(19) United States
(12) Patent Application Publication
(10) Pub. No.: US 2013/0301155 A1
(43) Pub. Date: Nov. 14, 2013

(54) INDICATION CIRCUIT FOR INDICATING TRANSFER RATE OF HARD DISK DRIVE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: BO TIAN, Shenzhen (CN); KANG WU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/868,142

(22) Filed: Apr. 23, 2013

(30) Foreign Application Priority Data
May 8, 2012 (CN) 2012101398534

(51) Int. Cl. G11B 27/36

(52) U.S. Cl. CPC G11B 27/36
USPC 360/31

(57) ABSTRACT

An indication circuit includes a control unit, a decode unit, and a display unit. The control unit is configured to obtain a transfer rate of a hard disk drive (HDD) from a power on self test (POST) code transmitted by a basic input-output system (BIOS) chip, and transmit a rate signal corresponding to the transfer rate of the HDD. The decode unit is configured to decode the rate signal to obtain the transfer rate, and output a decode signal corresponding to the transfer rate. The display unit is configured to display the transfer rate.

### BACKGROUND

1. Technical Field

The present disclosure relates to an indication circuit for indicating a transfer rate of a hard disk drive.

2. Description of Related Art

The serial advanced technology attachment (SATA) specification for hard disk drives defines many SATA revisions, such as SATA revision 2 and SATA revision 3. The SATA revision 2 defines a data transfer rate of 3.0 gigabit per second (GB/s), and the SATA revision 3 defines a faster data transfer rate which achieves 6.0 GB/s. By observing the blinking light emitting diode a user may know whether the hard disk drive is working or not, but not the transfer rate of the hard disk drive. This is an inconvenience.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an indication circuit of the present disclosure.

FIG. 2 is a circuit diagram of the indication circuit of FIG. 1.

### DETAILED DESCRIPTION

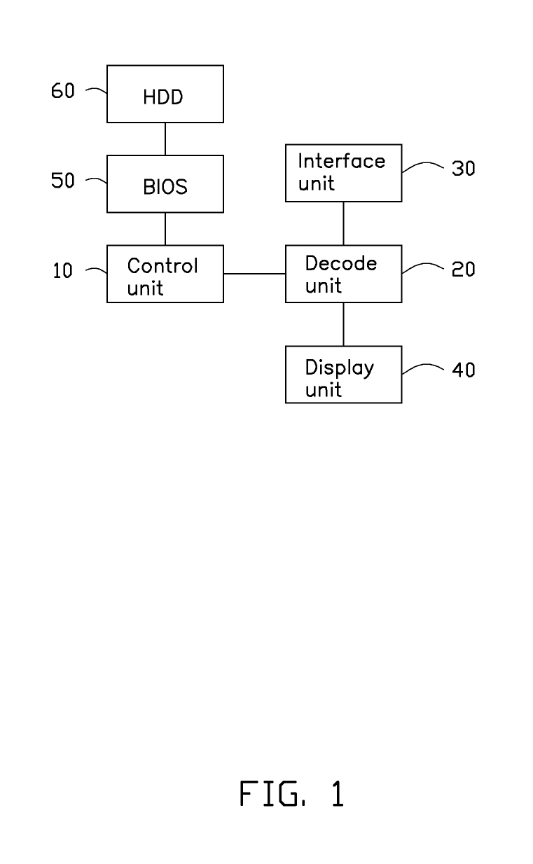

FIG. 1 shows an exemplary embodiment of an indication circuit. The indication circuit includes a control unit 10 configured to obtain a transfer rate of a hard disk drive (HDD) 60 through a basic input output system (BIOS) 50, a decode unit 20 configured to obtain a control signal from the control unit 10, a display unit 40 configured to display the transfer rate of the HDD 60, and an interface unit 30.

According to the working principle of a computer, a basic input-output system (BIOS) chip does power on self test (POST) during bootstrapping, and outputs a POST code including information of the transfer rate of the HDD 60 through an input-output port 80H.

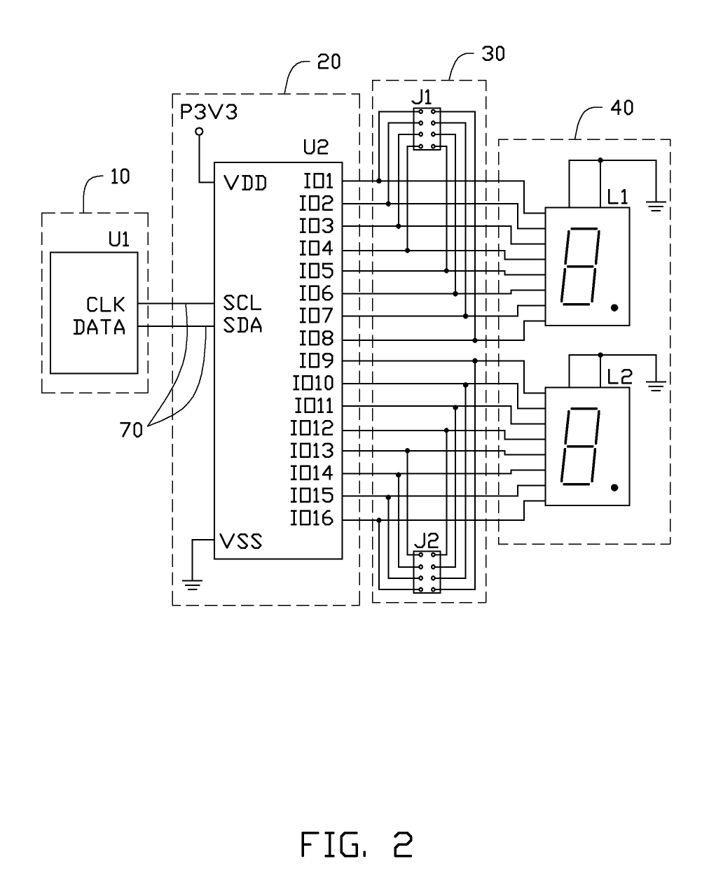

FIG. 2 shows a circuit diagram of the indication circuit. The control unit 10 includes a platform controller hub (PCH) chip U1. The PCH chip U1 is configured to analyze the POST code from the BIOS chip 50, to obtain the transfer rate of the HDD 60, such as 6.0 gigabit per second (GB/s) or 3.0 GB/s. The PCH chip U1 then transmits a rate signal including the transfer rate of the HDD 60 to the decode unit 20 through a system management bus (SMBus) 70. The PCH chip U1 includes a clock pin CLK and a data pin DATA.

The decode unit 20 includes a decode chip U2. A ground pin VSS of the decode chip U2 is grounded, a power pin VDD of the decode chip U2 is coupled to a power terminal P3V3. A clock input pin SCL and a data input pin SDA are coupled to the clock pin CLK and data pin DATA of the PCH U1, respectively. The decode chip U2 decodes the rate signal from the PCH chip U1, to obtain the transfer rate of the HDD 60, and transmits a decode signal through input-output pins IO1-IO16 to the interface unit 30 and the display unit 40.

The display unit 40 includes two seven-segment displays L1 and L2. Each seven-segment display includes eight data pins, and two ground pins grounded. The eight data pins of the seven-segment displays L1 are coupled to the input-output pins IO1-IO8 of the decode chip U2, respectively, and the eight data pins of the seven-segment displays L2 are coupled to the input-output pins IO9-IO16 of the decode chip U2, respectively. The display unit 40 is configured to display the transfer rate of the HDD 60 through the two seven-segment displays L1 and L2.

The interface unit 30 includes first and second connectors J1 and J2. Eight pins of the first connector J1 are coupled to the eight pins of the seven-segment display L1, respectively. Eight pins of the second connector J2 are coupled to the eight pins of the seven-segment display L2, respectively. The interface unit 30 is configured to transmit the decode signal to other displays. In other embodiments, the interface unit 30 may be omitted to save cost.

The PCH chip U1 obtains the transfer rate of the HDD 60 from the POST code output by the BIOS chip 50 during bootstrapping. The PCH chip U1 outputs the rate signal including the transfer rate of the HDD 60 through the SMBus 70 to the decode chip U2. The decode chip U2 then decodes the rate signal to obtain the transfer rate of the HDD 60, and outputs the decode signal corresponding to the transfer rate to the two seven-segment displays L1 and L2 through the input-output pins IO1-IO16. For example, if the transfer rate of the HDD is 6.0 GB/s, the seven-segment display L1 may display “6”, and the other seven-segment display L2 displays “0”.

Accordingly, it is convenient for a user to obtain the actual transfer rate of the HDD 60 through the display unit 40.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An indication circuit, comprising:
a control unit configured to obtain a transfer rate of a hard disk drive (HDD) from a power on self test (POST) code transmitted by a basic input output system (BIOS) chip, and transmit a rate signal corresponding to the transfer rate of the HDD;
a decode unit configured to decode the rate signal to obtain the transfer rate, and output a decode signal corresponding to the transfer rate; and
a display unit configured to receive the decode signal to display the transfer rate.

2. The indication circuit of claim 1, wherein the control unit comprises a platform controller chip (PCH), wherein the PCH chip comprises a first clock pin and a first data pin, configured to transmit the rate signal, the first clock pin and the first data pin are connected to the decode unit through a system management bus (SMBus).

3. The indication circuit of claim 2, wherein the decode unit comprises a decode chip, the decode chip comprises a second clock pin and a second data pin respectively coupled to the first clock pin and the first data pin of the PCH chip through the SMBus, the decode chip outputs the decode signal through first to sixtieth data input-output pins.

4. The indication circuit of claim 3, wherein the display unit comprises first and second seven-segment displays, each seven-segment display comprises eight data pins, and two ground pins grounded, the first to eighth pins of the first seven-segment display are coupled to the first to eighth data input-output pins of the decode chip, respectively, the first to eighth pins of the second seven-segment display are coupled to the ninth to sixtieth data input-output pins of the decode chip, respectively.

5. The indication circuit of claim 3, further comprising an interface unit, wherein the interface is configured to receive the decode signal.

6. The indication circuit of claim 5, wherein the interface unit comprises first to second connectors, first to eighth pins of the first connector are coupled to the first to eighth data input-output pins of the decode unit, respectively, first to eighth pins of the second connector are coupled to the ninth to sixtieth data input-output pins of the decode chip, respectively.
